(19) United States
(12) Patent Application Publication
(10) Pub. No.: US 2024/0116783 A1
(43) Pub. Date: Apr. 11, 2024

(54) ASSEMBLIES AND METHODS FOR TREATING POLLUTED WATER

(71) Applicant: OXYLE AG, Schlieren (CH)

(72) Inventor: Gerhard STAUFERT, Niedergösgen (CH)

(21) Appl. No.: 18/275,386

(22) PCT Filed: Jan. 31, 2022
(86) PCT No.: PCT/IB2022/050822

§ 371 Date: Aug. 1, 2023

(30) Foreign Application Priority Data
Feb. 2, 2021 (CH) 00098/21

(51) Int. Cl. C02F 1/467; C02F 1/34

(52) U.S. Cl. CPC C02F 1/4672; C02F 1/34; C02F 1/4676; C02F 2101/30

(57) ABSTRACT

According to the present invention there is provided assemblies for treating polluted water, the assemblies comprising, a vessel which defines a volume in which said polluted water can be located; piezoelectric element located within said volume; a means for straining the piezoelectric element so as to generate transient electric charges on a surface of said piezoelectric element so that said generated transient electric charges cause redox reactions which degrade pollutants in the polluted water. There is further provided corresponding methods for treating polluted water.

### FIELD OF THE INVENTION

The present invention concerns assemblies and methods for treating polluted water; and in particular assemblies and methods in which a piezoelectric element is strained so as to generate transient electric charges on a surface of said piezoelectric element, and wherein said generated transient electric charges cause redox reactions which degrade pollutants in the polluted water.

### BACKGROUND

Water pollution is an ever-increasing global problem. At present, due to the release of toxic and carcinogenic organic pollutants such as textile dyes, pesticides and pharmaceuticals, water pollution levels are increasing alarmingly.

Some existing methods which are used to treating polluted water involve removing recalcitrant pharmaceuticals, pesticides and synthetic dyes from water, using biological filtration, membrane filtration and activated carbon. Disadvantageously, these methods are inadequate as they each possess a low pollutant removal yield. Moreover, these methods work on the principle of adsorbing the pollutants from the water which is not suitable for some applications.

Other existing methods which are used to treat polluted water involve chemical oxidation processes that use hydroxyl radicals; these chemical oxidation processes work on the principle of degrading organic pollutants (i.e. micropollutants) that are in the water. Examples of chemical oxidation processes include advanced oxidation processes (AOPs) including ozone/hydrogen peroxide (H2O2), UV light/ozone; photocatalysis, electrolytic oxidation etc. However, these methods which use a chemical oxidation processes are inefficient for many applications as they cannot remove a broad range of pollutants, on the contrary these method are only capable of removing a limited range of pollutants (i.e. only certain type of pollutants). Also these methods rely upon the use of corrosive fuels that must be continuously replenished in enable the chemical oxidation processes to continue (e.g. H2O2 based treatments); also they method suffer from low reaction rates due to poor light penetration in murky or turbid polluted water.

It is an aim of the present invention to mitigate, or obviate, at least some of the disadvantages associated with existing methods/assemblies which are used to treat polluted water.

### SUMMARY OF INVENTION

According to an aspect of the present invention there is provided an assembly for treating polluted water having the features recited in independent claim 1.

According to a further aspect of the present invention there is provided a method for treating polluted water having the steps recited in independent claim 42.

The dependent claims recite, favourable features and/or steps of various embodiments.

### BRIEF DESCRIPTION OF THE DRAWINGS

Embodiments of the invention will be described, by way of example only, with reference to the following drawings in which:

FIG. 1a illustrates an assembly according to an embodiment of the present invention, which can be used to perform a method according to an embodiment of the present invention;

FIG. 1b illustrates an assembly according to another embodiment of the present invention, which can be used to perform a method according to an embodiment of the present invention;

FIG. 2a illustrates an assembly according to another embodiment of the present invention, which can be used to perform a method according to an embodiment of the present invention;

FIG. 2b illustrates an assembly according to another embodiment of the present invention, which can be used to perform a method according to an embodiment of the present invention;

FIG. 2c illustrates an assembly according to another embodiment of the present invention, which can be used to perform a method according to an embodiment of the present invention;

FIG. 3a illustrates an assembly according to another embodiment of the present invention, which can be used to perform a method according to an embodiment of the present invention;

FIG. 3a illustrates an assembly according to another embodiment of the present invention, which can be used to perform a method according to an embodiment of the present invention;

FIG. 4 illustrates an assembly according to another embodiment of the present invention, which can be used to perform a method according to an embodiment of the present invention;

FIG. 5a illustrates an assembly according to another embodiment of the present invention, which can be used to perform a method according to an embodiment of the present invention;

FIG. 5b illustrates an assembly according to another embodiment of the present invention, which can be used to perform a method according to an embodiment of the present invention.

### DETAILED DESCRIPTION

According to the present invention there is provided an assembly for treating polluted water, the assembly comprising, a vessel which defines a volume in which said polluted water can be located; piezoelectric element located within said volume; a means for straining the piezoelectric element so as to generate transient electric charges on a surface of said piezoelectric element so that said generated transient electric charges cause redox reactions which degrade pollutants in the polluted water.

In the preferred embodiments of the invention the means for straining the piezoelectric element comprises a means for deforming the piezoelectric element; the means for deforming the piezoelectric element is preferably a means for applying a mechanical force; for example in some embodiments the assembly comprises a means for applying a pulse of mechanical force to the piezoelectric element, the pulse of mechanical force causes mechanical deformation of the piezoelectric element thereby inducing strain in the piezoelectric element; as the pulse of mechanical force is applied to the piezoelectric element the strain induced in the piezoelectric element will increase; after the pulse of mechanical force is removed the piezoelectric element will, typically, continue to vibrate as it elastically returns to its original state. Thus, the application of the pulse of mechanical force to the piezoelectric element results in a change in the strain in the piezoelectric element over time, which gives rise to the generation of transient electric charges on a surface of said piezoelectric element. These transient electric charges on the surface of said piezoelectric element cause redox reactions which degrade pollutants in the polluted water. In other exemplary embodiments the assembly comprises a means for applying a cyclical mechanical force to the piezoelectric element (in other words a mechanical force is applied to the piezoelectric element (i.e. a means for applying a mechanical force at regular time intervals). Applying a cyclical mechanical force to the piezoelectric element causes cyclical mechanical deformation of the piezoelectric element thereby inducing strain in the piezoelectric element, the amount of strain in the piezoelectric element changing cyclically; strain increases when the mechanical force is applied to the piezoelectric element and decreases as the mechanical force is removed from the piezoelectric element.

During use the assembly can be used to perform a method for treating polluted water, which comprises the steps of, bringing said water in contact with piezoelectric element so that the pollutants in the water come into contact with the surfaces of the piezoelectric element; straining the piezoelectric element so as to generate transient electric charges on a surface of said piezoelectric element; using said generated transient electric charges to cause redox reactions which degrade pollutants in the water.

It should be understood that in the present application the assemblies and methods for treating polluted water according to the present invention, are assemblies and methods for reducing the amount of pollutants in the polluted water.

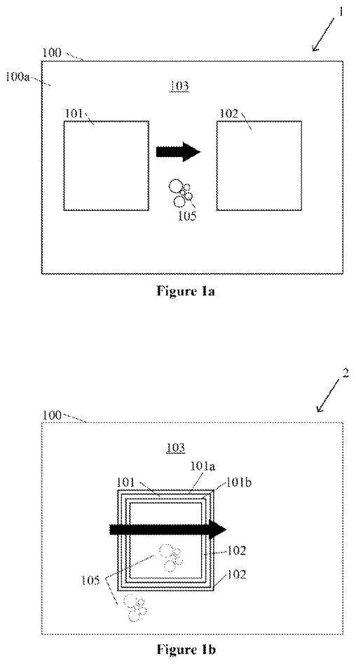

FIG. 1a illustrates an assembly 1 according to an embodiment of the present invention, for treating polluted water, which can be used to perform a method for treating polluted water according to an embodiment of the present invention.

The assembly 1 comprises, a vessel 100 which defines a volume 100a in which said polluted water 103, which is to be treated, can be located; a piezoelectric element 102 which is located within said volume 100a; and a means 101 for straining the piezoelectric element 102 so as to generate transient electric charges on a surface 102a of said piezoelectric element 102 so that said generated transient electric charges cause redox reactions which degrade pollutants in the polluted water 103.

In the assembly 1 the means 101 for straining the piezoelectric element 102 comprises a means 101 for generating bubbles 105 in the polluted water 103. In this example means 101 for generating bubbles 105 in the polluted water 103 comprises a hydrodynamic cavitation device 101 which, when operated, generates cavitation bubbles 105 in the polluted water 103. It should be noted that in the present application the term hydrodynamic cavitation device 101 means any device which is operable to cause the polluted water 103 to flow at a velocity (e.g. 1 m/s to 50 m/s) which is above a predefined velocity. Most preferably the hydrodynamic cavitation device 101 is operable to cause the polluted water 103 to flow at a velocity such the polluted water 103 flows at a predefined velocity relative to the hydrodynamic cavitation device 101; for example, the hydrodynamic cavitation device 101 may be operable to cause the polluted water 103 to flow at a velocity such the polluted water 103 flows at a velocity of between 5 m/s-40 m/s relative to the hydrodynamic cavitation device 101. It should be understood that the hydrodynamic cavitation device 101 may take any suitable form. For example, the hydrodynamic cavitation device 101 may comprise a venturi tube to cause the polluted water 103 to flow at a velocity which is above a predefine velocity. In another embodiment the hydrodynamic cavitation device 101 may comprise one or more rotating elements (which can be arranged to be fully, or partially, submerged within the polluted water 103) which may be operated to cause the polluted water 103 to flow at a velocity which is above a predefine velocity. It should be understood that the present invention is not limited to requiring a hydrodynamic cavitation device 101; rather, any suitable means for causing the polluted water 103 to flow at a velocity which is above a predefine velocity may be used. Furthermore, it should be noted that the present invention is not limited to requiring a hydrodynamic cavitation device 101 to generate the bubbles, rather any suitable means may be used.

As illustrated in FIG. 1a, the piezoelectric element 102 is located within the volume 100a of the vessel 100 and is mechanically independent of the hydrodynamic cavitation device 101. Preferably assembly 1 further comprises a means for generating a flow within the polluted water 103 which is in the vessel 100; any suitable means may be used to generate said flow of the polluted water 103. Most preferably the polluted water 103 which is in the vessel 100 is made to flow so that the cavitation bubbles 105 which are generated by the hydrodynamic cavitation device 101, are transported by the polluted water 103, from the hydrodynamic cavitation device 101 towards the piezoelectric element 102. In FIG. 1a the direction of flow of the polluted water 103 within the vessel 100 is indicated by the arrow shown. In should be noted that in an embodiment the hydrodynamic cavitation device 101 also defines the means for generating a flow within the polluted water 103; so in other words the hydrodynamic cavitation device 101 generates the bubbles 105 and also creates a flow within the polluted water 103 which transports the bubbles 105 towards the piezoelectric element 102. Most preferably a cavitation number of the flow of said polluted water 103 which is created by the hydrodynamic cavitation device 101 is in the range of 0.5 to 0.1. The cavitation number is the difference between a pressure of the polluted water 103 downstream of the hydrodynamic cavitation device 101 and a pressure of the polluted water 103 at the hydrodynamic cavitation device 101, divided by a product of half of the density and squared local velocity of the polluted water 103 at the hydrodynamic cavitation device 101. The cavitation number is defined by the formula: σ_d=p_d−p_c/(0.5*ρ*v_c\hat{ }2); wherein σ_d is the cavitation number; p_d is a pressure of the polluted water 103 downstream of the hydrodynamic cavitation device 101 (preferably p_d is a pressure of the polluted water 103 downstream of the hydrodynamic cavitation device 101 where the flow of the polluted water 103 has normalized, i.e. the flow of the polluted water 103 is substantially equal to the flow of the polluted water 103 upstream of the hydrodynamic cavitation device 101); p_c is a pressure of the polluted water 103 at the hydrodynamic cavitation device 101; v_c is the velocity of the polluted water 103 at the hydrodynamic cavitation device 101; and ρ is a density of the polluted water 103. Most preferably the hydrodynamic cavitation device 101 is configured to cause a cavitation number of the flow of the polluted water 103 which is, less than 0.5; or less than 0.2; or below 0.125.

It should be understood that in each of the assembly embodiments described in the present application, the piezoelectric element 102 may comprise any material which has piezoelectric properties; the material may comprise ceramic and/or polymer and/or a composite material.

In a preferred embodiment the piezoelectric element 102 comprises a composite material comprising a matrix which comprises a polymeric material, and piezoelectric particles embedded in the matrix. Preferably, the polymeric matrix comprises one or more of the following poly(vinylidene fluoride) PVDF, poly(vinylidene fluoride-co-trifluoroethylene) PVDF-TrFE, poly(vinylidene fluoride-co-trifluoroethylene-co-chlorofluoroethylene) PVDF-TrFE-CFE, Poly(vinylidene fluoride-hexafluoropropylene) PVDF-HFP, Poly(vinylidene fluoride-bromotrifluoroethylene) PVDF-BTFE, poly(L-lactic acid) PLLA, Polyarcrylonitril (PAN), poly(α-hydroxy acid) PAHA, Nylon-7 or Nylon-11. Preferably, the piezoelectric particles which are embedded in the matrix comprise one or more of Barium-Calcium-Zirconate-Titanate (BCZT), Barium-Calcium-Titanate (BCT), potassium-sodium niobate (KNN), Lithium-Niobiate (LiNbO3), Lead-zirconate-titanate (PZT), Zinc-Oxide (ZnO), Barium-Titanate (BaTiO3), Bismuth Ferrite (BiFeO3). Most preferably the piezoelectric particles which are embedded in the matrix have a diameter size between 10 nm-50 nm or between 10 nm-100 nm; most preferably the piezoelectric particles have a diameter size of about 10 nm.

Preferably, the piezoelectric element 102 is configured so that it to be easily deformed by a flow of polluted water 103; for example, the piezoelectric element 102 may be in the form of a sheet having a thickness of between 10 um to 200 um or a thickness between 200 um to 2000 um; in another example the piezoelectric element 102 is in the form of a fiber with a diameter of between 10 um to 200 um or a diameter of between 200 um to 2000 um. Preferably, the piezoelectric element 102 comprises an elastic material with a macroscopic young's modulus between 10 MPa and 500 MPa, allowing the piezoelectric element 102 to be easily deformed by flow of the polluted water 103 around it. The length and/or width of the piezoelectric element 102 is preferably such that when one end of the piezoelectric element 102 is fixed the other end can be moved a distance of between 0.5 mm to 5 mm, or moved a distance of between 5 mm to 50 mm, without causing damage or permanent deformation of the piezoelectric element 102.

Preferably, the piezoelectric material 102 is porous and/or has a porous surface. Advantageously a piezoelectric material 102 which is porous and/or has a porous surface increases the contact area of the piezoelectric material 102 thus enabling a greater volume of the polluted water 103 to come into contact with the piezoelectric material 102 in a shorter time. It should be noted that, in the present invention, it is not necessary for the polluted water 103 to permeate through the piezoelectric material 102 in order to degrade pollutants in the polluted water.

Preferably, the piezoelectric element 102 occupies less than 10% of the total volume 101a of the vessel 100, or the piezoelectric element 102 occupies less than 20% of the total volume 101a of the vessel 100, or the piezoelectric element 102 occupies less than 50% of the total volume 101a of the vessel 100, or the piezoelectric element 102 occupies less than 70% of the total volume 101a of the vessel 100.

The assembly may comprise a single piezoelectric element 102 or may comprise of a plurality of piezoelectric elements 102. In an embodiment a plurality of piezoelectric elements 102 are provided. For example, the plurality of piezoelectric elements may comprise particles which each comprise piezoelectric material. The particles may have any suitable shape; for example, the particles may be spherical, cuboidal or cylindrical shape. Most preferably the particles have a diameter of about 50 um, or have a diameter of about 100 um, or have a diameter of about 200 um, or have a diameter of up to 5000 um. The particles preferably are configured so that they each have a density which is equal to the density of water. The particles are easily transported by the prevalent flow of the polluted water 103.

The assembly 1 can be used to perform a method for treating the polluted water 103, according to an embodiment of the present invention. During use, the hydrodynamic cavitation device 101 is used to generate bubbles 105 within the polluted water 103. In a preferred embodiment, in order to generate bubbles 105 in the polluted water 103, the hydrodynamic cavitation device 101 flows the polluted water 103 from a first volume through a rigid structure which defines a second volume, wherein the second volume is smaller than the first volume so that as the polluted water 103 flows through the rigid structure it causes an increase in the velocity of the volume of polluted water 103 flowing through the rigid structure and causes a pressure to drop locally, at the rigid structure, below a saturated vapor pressure of the polluted water 103 (the vapor pressure of the polluted water 103 is dependent on the water temperature, e.g. ˜1000 Pa at 7° C. or ˜3160 Pa at 25° C.) and thus generate bubbles 105 within the polluted water 103.

The bubbles 105 are then moved towards the piezoelectric element 102. In one embodiment the bubbles 105 simply migrate passively towards the piezoelectric element 102; in another embodiment the method involves generating a flow within the polluted water 103 and transporting the bubbles 105 in said flow towards the piezoelectric element 102. For example, in a preferred embodiment the hydrodynamic cavitation device 101 also creates a flow within the polluted water 103 which moves the bubbles 105 towards the piezoelectric element 102 (i.e. when the hydrodynamic cavitation device 101 is operated, it creates rapid changes of pressure in polluted water 103 which lead to the generation of small vapor-filled cavities in places where the pressure is below said saturated vapor pressure—said small vapor-filled cavities define said bubbles 105; the rapid changes of pressure also creates a flow in the polluted water 103, which is used to transport the bubbles 105 towards the piezoelectric element 102). Most preferably each bubble has a diameter in the range 1 microns to 1000 microns.

In a further embodiment a step of applying a vacuum to the polluted water 103 in the vessel 100 is carried out so as to support the generation of said bubbles 105. In one preferred embodiment the vessel 100 is located in a vacuum chamber and a vacuum is generated within the vacuum chamber so as to reduce the pressure within the vacuum chamber. As achieving a local pressure lower than the saturated vapor pressure of the polluted water 103 is favourable to achieving cavitation, locating the vessel 100 in a vacuum environment lowers the flow velocity requirements necessary to achieve cavitation. Most preferably the vacuum is configured to have a residual pressure in the range of 0.1 kPa to 10 kPa to the ambient atmosphere of said polluted water 103.

The bubbles 105 then collapse within the polluted water 103. The collapsing of each bubble 105 generates a respective shockwave which is transmitted to the piezoelectric element 102; the shockwaves cause strain within the piezoelectric element 102.

It should be understood that bubbles 105 can collapse anywhere within the polluted water 103. Regardless of where a bubble 105 collapses it will create a shockwave which will be transmitted (e.g. via the polluted water 103 as a medium though which the shockwave can travel) to the piezoelectric element 102. However, the closer a bubble 105 is to the piezoelectric element 102 when it collapses the larger the amount of the shockwave will be received by the piezoelectric element 102, and thus the greater the strain caused in the piezoelectric element 102. Accordingly, preferably the bubbles 105 collapse at the piezoelectric element 102 (e.g. at the surface 102a of the piezoelectric element 102), or, in close proximity to the piezoelectric element 102. For example, a bubble 105 impacting the surface 102a of the piezoelectric element 102 will cause that bubble 105 to collapse. When a bubble 105 collapses at the surface 102a of the piezoelectric material then the shockwave generated by that collapsing bubble 105 is transmitted directly into the piezoelectric element 102; whereas the shockwave generated by a bubble 105 that collapses at a location away from the surface 102a of the piezoelectric element 102 will first need to propagate through the polluted water 103 to the surface 102a of the piezoelectric element 102 before it causes stain in the piezoelectric element 102. In the preferred embodiment the bubbles 105 move towards the piezoelectric element 102 and collapse upon impacting the surface 102a of the piezoelectric element 102.

The strain caused in the piezoelectric element 102 by the shockwaves generated by the collapsing of the bubbles 105, give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103. In one example, the strain caused in the piezoelectric element 102 by the shockwaves generated by the collapsing of the bubbles 105 is an arbitrary, time-dependent strain that generates a time-averaged absolute piezoelectric surface potential of 1 mV to 5V.

In a further embodiment the method further comprises the step of using said shockwaves to destroy organic pollutants in the polluted water 103.

A limiting factor of existing assemblies and techniques for removing pollutants from polluted water is that they fail to adequately bring the pollutant into contact with the material that removes said pollutant. The common approach to overcome this limitation is to increase the amount of the material that removes the pollutant. The drawbacks of this approach is that, firstly, the increase in said material reduces the volume within vessel available for polluted water (since the material which removed the pollutants occupies a greater amount of the volume within the vessel), thus reducing the volume of polluted water which can be treated, and secondly, that it greatly increases the costs of the assemblies and techniques. The assembly of the present invention solves these problems: since the polluted water can be flowed at high velocities through the hydrodynamic cavitation device 101 and the piezoelectric element 102 is easily moved around by the prevalent flow in the polluted water 103. This results in the organic pollutant coming into contact with the piezoelectric element 102 more quickly without having to reduce the volume available in the vessel and without greatly increasing costs of the assembly.

FIG. 1b illustrates an assembly 2 according to another embodiment of the present invention, which can be used to perform a method according to an embodiment of the present invention.

The assembly 2 comprises many of the same features as the assembly 1 shown in FIG. 1a, and like features are awarded the same reference numbers. However, unlike the assembly 1, in the assembly 2 the piezoelectric element 102 is not mechanically independent of the means 101 for straining the piezoelectric element; rather in the assembly 2 the piezoelectric element 102 is in the form of a coating on the means 101 for straining the piezoelectric element.

More specifically, in the assembly 2 the means 101 for straining the piezoelectric element 102 comprises a means 101 for generating bubbles 105 in the polluted water 103. In this example the means 101 for generating bubbles 105 in the polluted water 103 comprises a hydrodynamic cavitation device 101 which, when operated, generates cavitation bubbles 105 in the polluted water 103. The piezoelectric element 102 is in the form of a coating on the hydrodynamic cavitation device 101. It should be noted that the piezoelectric element 102 may be a coating on an outer-surface 101a of the hydrodynamic cavitation device 101, or, alternatively the piezoelectric element 102 may be a coating on an inner-surface 101b of the hydrodynamic cavitation device 101. An outer-surface 101a of the hydrodynamic cavitation device 101 is an external surface of a body belonging to the hydrodynamic cavitation device 101, which is submerged in the polluted water 103 and which the polluted water 103 can flow along, such as a surface of one or more blades of a propeller belonging to the hydrodynamic cavitation device 101, or a surface of a hydrofoil belonging to the hydrodynamic cavitation device 101; an inner-surface 101b of the hydrodynamic cavitation device 101 is an internal surface of a body belonging to the hydrodynamic cavitation device 101 which is submerged in the polluted water 103 and which the polluted water 103 can flow along, such as a surface of a venturi tube (belonging to the hydrodynamic cavitation device 101) which the polluted water 103 contacts when flowing through the venturi tube, or as surface of an orifice or nozzle which the polluted water 103 contacts when flowing through the orifice or nozzle.

The assembly 2 operates in the same manner as the assembly 1 described above.

In the assembly 1 the piezoelectric element 102 is located within the volume 100a of the vessel 100 and is mechanically independent of the hydrodynamic cavitation device 101; in the assembly 2 the piezoelectric element 102 is in the form of a coating on the means 101 for straining the piezoelectric element. However, it should be understood that the piezoelectric element 102 may take any suitable form. For example, the piezoelectric element 102 may be material in form of one or multiple solid bodies, the piezoelectric material may further be provided in the form of micro- or nanoparticles, or particulate matter.

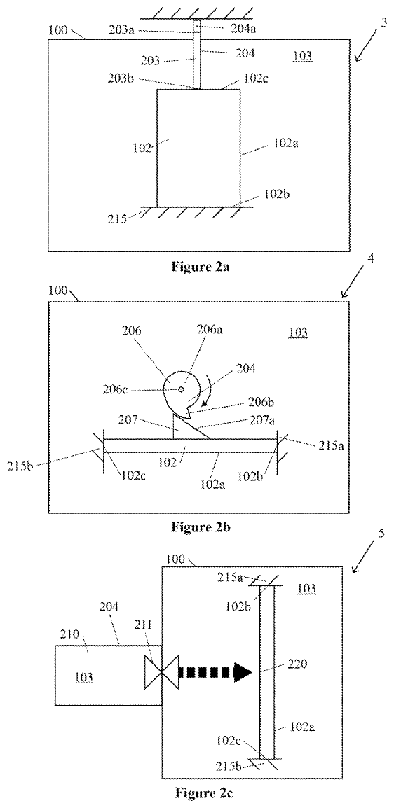

FIG. 2a illustrates an assembly 3 according to another embodiment of the present invention, which can be used to perform a method according to an embodiment of the present invention.

The assembly 3 comprises many of the same features as the assembly 1 shown in FIG. 1a, and like features are awarded the same reference numbers.

In the assembly 3 the means for deforming the piezoelectric element 102 comprises a means 204 for applying a mechanical force to the piezoelectric element. Specifically, in this example, a means 204 for applying a mechanical force to the piezoelectric element 102 comprises a means 204 for applying a pulse of mechanical force to the piezoelectric element 102. In the assembly 3, the means 204 for applying a pulse of mechanical force to the piezoelectric element 102 comprises a mechanical pulse generator 204a which is selectively operable to provide a pulse of mechanical force, a force transmitting member 203 which is connected at a first end 203a to the mechanical pulse generator 204a and has a second, opposite, end 203b which is a free end; the force transmitting member 203 is positioned with respect to the piezoelectric element 102 such that when the mechanical pulse generator 204a is operated to provide a mechanical pulse of force, the mechanical pulse of force moves the force transmitting member 203 towards the piezoelectric element 102 so that the second end 203b of the force transmitting member 203 pushes against the piezoelectric element 102 to mechanically deform the piezoelectric element 102, and thus transmitting the mechanical pulse of force which was generated by the mechanical pulse generator 204a to the piezoelectric element 102. After the mechanical pulse of force is transmitted to the piezoelectric element 102 the piezoelectric element 102 is allowed to vibrate freely. The piezoelectric element 102 vibrates by performing a motion according to a damped vibration with a frequency of its eigenfrequency until all the potential energy of the original deformation is dissipated. Further, due to the instantaneous release of the mechanical force, the piezoelectric element will vibrate internally at higher, local eigenfrequencies.

Preferably the force transmitting member 203 is positioned with respect to the piezoelectric element 102 such that the second end 203b of the force transmitting member 203 abuts the piezoelectric element 102; when the mechanical pulse generator 204a is operated to provide a mechanical pulse of force, the mechanical pulse of force moves the force transmitting member 203 towards the piezoelectric element 102 so that the second end 203b of the force transmitting member 203 pushes against the piezoelectric element 102 (thus transmitting the mechanical pulse of force which was generated by the mechanical pulse generator 204a to the piezoelectric element 102) mechanically deforming the piezoelectric element 102. After the mechanical pulse of force is transmitted to the piezoelectric element 102 the piezoelectric element 102 is allowed to vibrate. In another embodiment the force transmitting member 203 is positioned with respect to the piezoelectric element 102 such that the second end 203b of the force transmitting member 203 is in close proximity to the piezoelectric element 102 and there is a gap between the second end 203b of the force transmitting member 203 and the piezoelectric element 102; when the mechanical pulse generator 204a is operated to provide a mechanical pulse of force, the mechanical pulse of force moves the force transmitting member 203 towards the piezoelectric element 102 so that the second end 203b of the force transmitting member 203 traverses the gap and strikes against the piezoelectric element 102 (thus transmitting the mechanical pulse of force which was generated by the mechanical pulse generator 204a to the piezoelectric element 102) mechanically deforming the piezoelectric element 102; in this embodiment after the second end 203b of the force transmitting member 203 traverses the gap and strikes against the piezoelectric element 102 the force transmitting member 203 moves away from the piezoelectric element 102 such that the gap between the second end 203b and piezoelectric element 102 is reestablished. After the mechanical pulse of force is transmitted to the piezoelectric element 102 the piezoelectric element 102 is allowed to vibrate freely.

In the assembly 3 the piezoelectric element 102 is anchored at first end 102b to a fixed, immoveable part 215 of the assembly 3, so that the first end 102b is immovable; and a second opposite end 102c of the piezoelectric element 102 is a free end. The second opposite end 102c of the piezoelectric element 102 is available to either be in abutment with the second end 203b of the force transmitting member 203, or, there is a gap between the second end 203b of the force transmitting member 203 and the second opposite end 102c of the piezoelectric element 102 and the second end 203b of the force transmitting member 203 can traverse the gap, when the mechanical pulse generator 204a is operated to provide a mechanical pulse of force, so that the second end 203b of the force transmitting member 203 can strike the second opposite end 102c of the piezoelectric element 102.

The assembly 3 can be used to perform a method for treating the polluted water 103, according to an embodiment of the present invention. During use, the mechanical pulse generator 204a is selectively operated to provide a pulse of mechanical force; the pulse of mechanical force is transmitted to the piezoelectric element 102 via the force transmitting member 203 where it creates strain within the piezoelectric element 102. For example, the pulse of mechanical force which is generated by the mechanical pulse generator 204a may move force transmitting member 203 so that the piezoelectric element 102 is compressed between the second end 203b of the force transmitting member 203 and the immoveable part 215, therefore creating strain within the piezoelectric element 102. In other words the pulse of mechanical force which is generated by the mechanical pulse generator 204a will cause mechanical deformation of the piezoelectric element 102.

After the pulse of mechanical force is transmitted to the piezoelectric element 102 to cause mechanical deformation of the piezoelectric element 102, the piezoelectric element 102 will, preferably, be left to vibrate freely (as it elastically returns to its original state). The level of strain in the piezoelectric element 102 will change over time from a state in which the piezoelectric element 102 has a maximum level of strain when the full amount of mechanical force which was generated by the pulse generator 204a is applied to the mechanical pulse generator 204a will cause mechanical deformation of the piezoelectric element 102, to a minimum level of strain when the piezoelectric element 102 has elastically returned to its original state (i.e. the state which the piezoelectric element 102 had prior to the application of the pulse of mechanical force being applied to the piezoelectric element 102).

This change in strain within the piezoelectric element 102 over time, give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103. In one example, the strain caused by the application of the pulse of mechanical force to the piezoelectric element 102 is an arbitrary, time-dependent strain that generates a time-averaged absolute piezoelectric surface potential of 1 mV to 5V.

FIG. 2b illustrates an assembly 4 according to another embodiment of the present invention, which can be used to perform a method according to an embodiment of the present invention.

The assembly 4 comprises many of the same features as the assembly 3 shown in FIG. 2a, and like features are awarded the same reference numbers.

In the assembly 4 the means for deforming the piezoelectric element 102 comprises a means 204 for applying a mechanical force to the piezoelectric element. Specifically, in this example, a means 204 for applying a mechanical force to the piezoelectric element 102 comprises a means 204 for applying a pulse of mechanical force to the piezoelectric element 102. In the assembly 4, the means 204 for applying a pulse of mechanical force to the piezoelectric element 102 comprises a movable body, which is configured such that when the movable body 206 which is configured so that when it is moved it applies a pulse of force to piezoelectric element 102 which mechanically deforms the piezoelectric element.

In the assembly 4 the movable body 206 is a rotatable body 206 which has an asymmetric shape. The rotatable body 206 is configured so that it can be selectively rotated about a rotation axis 206c. In this embodiment the rotatable body 206 is configured to rotate about the rotation axis 206c and has an asymmetric-shaped cross section taken along a plane which is perpendicular to said rotation axis 206c. Specifically the rotatable body 206 comprises a substantially circular body 206a which comprise a protruding member 206b which is located at a portion of the periphery of the circular body 206a. The protruding member 206b has a tapered profile. It should be understood that the rotatable body 206 may comprises any number of protruding members each of which being located at a portion of the periphery of the circular body 206a; for example, in one embodiment the rotatable body 206 comprises a plurality of protruding members each of which being located at a portion of the periphery of the circular body 206a. Also, it should be understood that the protruding member(s) may have any suitable shape (for example the protruding member(s) may have a square or rectangular or triangular cross section);

In this embodiment the piezoelectric element 102 is anchored at a first end 102b to a fixed, immoveable part 215a of the assembly 4, so that the first end 102b is immovable; and the piezoelectric element 102 is anchored at a second end 102c to a fixed, immoveable part 215b of the assembly 4, so that the second end 102c is immovable. It should be understood that the piezoelectric element 102 may be anchored to a fixed, immoveable part 215a of the assembly 4, along the whole of a perimeter of the piezoelectric element 102.

The assembly 4 further comprises an intermediate member 207 which is mounted on the piezoelectric element 102. Preferably the intermediate member 207 is mounted on the piezoelectric element 102 between the first and second ends 102b,102c. Preferably the intermediate member 207 is fixed to the piezoelectric element 102. The intermediate member 207 is wedge-shaped (however it should be understood that the intermediate member 207 may take any suitable shape e.g. the intermediate member 207 may be cuboid-shaped). The intermediate member 207 comprises a surface 207a, which the protruding member 206b on the rotatable body 206 can abut. In another embodiment the intermediate member 207 may be integral to the piezoelectric element 102; for example, the piezoelectric element 102 may be shaped so that it has a wedge-shaped protrusion which comprises a surface 207a, which the protruding member 206b on the rotatable body 206 can abut; in such an embodiment the intermediate member 207 may comprise piezoelectric material.

The rotatable body 206 and intermediate member 207 are arranged with respect to one another such that when the rotatable body 206 rotates, the protruding member 206b on the rotatable body 206 will abut the intermediate member 207 to apply a mechanical force to the intermediate member 207 as the rotatable body 206 is rotated about the rotation axis 206c; said mechanical force is in turn transmitted to the piezoelectrical element 102 on which the intermediate member 207 is mounted. In this example, since the protruding member 206b has a tapered profile and since the intermediate member 207 is wedge-shaped the amount of mechanical force which is transmitted to the piezoelectrical element 102 will increase as the rotatable body 206 rotates about the rotation axis 206c, until the rotatable body 206 rotates to a position wherein protruding member 206b no longer abuts the intermediate member 207. Said increase in amount of mechanical force will result in a corresponding increase in the strain in the piezoelectric element 102 over time.

The increase in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103. In one example, the strain caused by the application of the pulse of mechanical force to the piezoelectric element 102 is an arbitrary, time-dependent strain that generates a time-averaged absolute piezoelectric surface potential of 1 mV to 5V.

Likewise, when the rotatable body 206 rotates to a position wherein protruding member 206b no longer abuts the intermediate member 207, the mechanical force which the protruding member 206b was applying to the intermediate member 207 is released and the piezoelectric element 102 will elastically return to its original state (i.e. the state which the piezoelectric element 102 had prior to when the protruding member 206b on the rotatable body 206 abutted the intermediate member 207 to apply a mechanical force to the intermediate member 207). In other words, there will be a decrease in amount of mechanical force applied to the piezoelectric element 102 and thus a decrease in the strain in the piezoelectric element 102 over time. However, the piezoelectric element 102 may vibrate as the piezoelectric element 102, elastically returns, to its original state. The piezoelectric element 102 returns to its original state by performing a motion according to a damped vibration with a frequency of its eigenfrequency until all the potential energy of the original deformation is dissipated. Further, due to the instantaneous release of the mechanical force, the piezoelectric element will vibrate internally at higher, local eigenfrequencies.

The decrease in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103. In one example, the strain caused by the application of the pulse of mechanical force to the piezoelectric element 102 is an arbitrary, time-dependent strain that generates a time-averaged absolute piezoelectric surface potential of 1 mV to 5V.

In variation of this embodiment the rotatable body 206 is arranged contact the piezoelectric element 102 directly so that the rotatable body 206 applies a force directly to the piezoelectric element 102 when the rotatable body 206 is rotated.

In another variation of this embodiment, the rotatable body 206 and/or the protrusion 206b has the same composition as the piezoelectric element 102; in other words, the rotatable body 206 and/or the protrusion 206b comprise piezoelectric material. In this variation, the rotatable body 206 and/or the piezoelectric element 102 are deformed resulting in reactive radical species being created on the surfaces of the rotatable body 206 and/or the piezoelectric element 102; therefore, resulting in an increase in the radical species available within the assembly to degrade pollutants in the polluted water 103.

FIG. 2c illustrates an assembly 5 according to another embodiment of the present invention, which can be used to perform a method according to an embodiment of the present invention.

The assembly 5 comprises many of the same features as the assembly 4 shown in FIG. 2b, and like features are awarded the same reference numbers.

In the assembly 5 the means for deforming the piezoelectric element 102 comprises a means 204 for applying a mechanical force to the piezoelectric element 102. In this example the means 204 for applying a mechanical force to the piezoelectric element 102 may be selectively operated to apply a pulse of mechanical force to the piezoelectric element 102. In the assembly 5, the means 204 for applying a pulse of mechanical force to the piezoelectric element 102 comprises, a pressurizing reservoir 210, which can hold said polluted water 103 (i.e. either the entire volume of the polluted water 103 in the assembly, or, just a portion of the entire volume of the polluted water 103 in the assembly), and wherein the pressurizing reservoir 210 is configured such that it is operatable to increase the pressure of the polluted water 103 which it holds.

The pressurizing reservoir 210 is fluidly connected to the vessel 100 via a valve 211 which is selectively moveable between an open and closed position. In this example the valve 211 is located opposite a center 220 of the piezoelectric element 102 (although it is not essential to the invention that the valve 211 is located opposite a center 220 of the piezoelectric element 102). When the valve 211 is in an open position a volume of pressurized polluted water 103 can flow from the pressurizing reservoir 210 into the vessel 100, and the pressurized polluted water 103 flows against the piezoelectric element 102 so that the pressurized polluted water 103 applies a force to the piezoelectric element 102 which increases the strain in the piezoelectric element 102.

The piezoelectric element 102 is anchored at a first end 102b to a fixed, immoveable part 215a of the assembly 4, so that the first end 102b is immovable; and the piezoelectric element 102 is anchored at a second end 102c to a fixed, immoveable part 215b of the assembly 4, so that the second end 102c is immovable. It should be understood that the piezoelectric element 102 may be anchored to a fixed, immoveable part of the assembly 4, along the whole of a perimeter of the piezoelectric element 102.

The assembly 5 can be used to perform a method for treating the polluted water 103, according to an embodiment of the present invention. During use a volume of polluted water 103 which is to be treated is provided in the pressurizing reservoir 210. The valve 211 is configured to be in a closed position. The pressure inside the pressurizing reservoir 210 increased to a predefined level so as to increase the pressure of the volume of polluted water 103 which is in the pressurizing reservoir 210.

While maintaining the pressure in the pressurizing reservoir 210 increased at said predefined level, the valve 211 is then moved to an open position. The pressurized volume of polluted water 103 flows from the pressurizing reservoir 210 into the vessel 100, and as it does so it flows against the piezoelectric element 102. In this example since the valve 211 is located opposite the center 220 of the piezoelectric element 102, the pressurized volume of polluted water 103 will flow from the pressurizing reservoir 210 and will impact the piezoelectric element 102 close to the center 220 of the piezoelectric element 102. The impact of the pressurized volume of polluted water 103 on the piezoelectric element 102 will cause an increase in the stain in the piezoelectric element 102.

The increase in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103. In one example, the strain caused by the application of the pulse of mechanical force to the piezoelectric element 102 is an arbitrary, time-dependent strain that generates a time-averaged absolute piezoelectric surface potential of 1 mV to 5V.

Likewise, after the pressurized volume of polluted water 103 has impacted the piezoelectric element 102, and there is no more polluted water 103 flowing from the pressurizing reservoir 210 (either because there is no more polluted water 103 left in the pressurizing reservoir 210 or because the valve 211 has been moved to a closed position), there will be no more pressurized volume of polluted water 103 impacting the piezoelectric element 102 (however the piezoelectric element 102 may continue to vibrate from the prior impact of the pressurized volume of polluted water 103 for a period of time). The piezoelectric element 102 will thus elastically return to its original state (i.e. the state which the piezoelectric element 102 had prior to when the pressurized volume of polluted water 103 impacted the piezoelectric element 102), thus there will be a decrease in the strain in the piezoelectric element 102 over time. The piezoelectric element 102 returns to its original state by performing a motion according to a damped vibration with a frequency of its eigenfrequency until all the potential energy of the original deformation is dissipated. Further, due to the instantaneous release of the mechanical force, the piezoelectric element will vibrate internally at higher, local eigenfrequencies.

The decrease in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103. In one example, the strain caused by the application of the pulse of mechanical force to the piezoelectric element 102 is an arbitrary, time-dependent strain that generates a time-averaged absolute piezoelectric surface potential of 1 mV to 5V.

In one embodiment the method comprises a step of closing the valve 211 after a predefined duration of time has passed after opening the valve 211. In another embodiment the method comprises a step alternating the position of the valve 211 between its open position and closed position at a rate of 1 Hz to 5 kHz. In another embodiment the assembly 5 comprises a controller which is configured to alternate the position of the valve 211 between its open position and closed position at a predefined frequency.

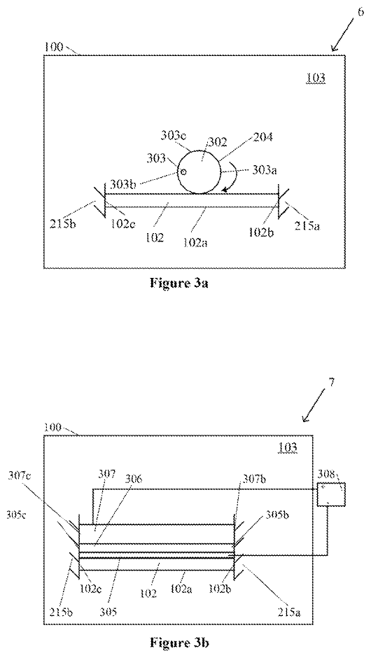

FIG. 3a illustrates an assembly 6 according to another embodiment of the present invention, which can be used to perform a method according to an embodiment of the present invention.

The assembly 6 comprises many of the same features as the assembly 4 shown in FIG. 2b, and like features are awarded the same reference numbers.

In this embodiment the piezoelectric element 102 is anchored at a first end 102b to a fixed, immoveable part 215a of the assembly 6, so that the first end 102b is immovable; and the piezoelectric element 102 is anchored at a second end 102c to a fixed, immoveable part 215b of the assembly 6, so that the second end 102c is immovable. It should be understood that the piezoelectric element 102 may be anchored to a fixed, immoveable part of the assembly 6, along the whole of a perimeter of the piezoelectric element 102.

In the assembly 6 the means for straining the piezoelectric element 102 comprises a means 204 for applying a mechanical force to the piezoelectric element 102 which mechanically deforms the piezoelectric element 102. Specifically, in this example, a means 204 for applying a mechanical force to the piezoelectric element 102 comprises a means 204 for applying a cyclical mechanical force to the piezoelectric element 102 (i.e. a means 204 for applying a mechanical force at regular time intervals). In this embodiment a plurality of mechanical forces, are applied consecutively to the piezoelectric element, wherein a time interval between the application of each mechanical force is constant.

In the assembly 6, the means 204 for applying a cyclical mechanical force to the piezoelectric element 102 comprises a rotatable body 302 which comprises eccentric axle 303 which defines an axis of rotation about which the rotatable body 302 can be rotated. Said rotatable body 302 is positioned such that it mechanically abuts the piezoelectric element 102 during at least some portion of a rotation about said eccentric axle 303 (axis of rotation), to apply a mechanical force to the piezoelectric element 102. Most preferably said rotatable body 302 is positioned such that it mechanically abuts the piezoelectric element 102 over a whole rotation about said eccentric axle 303 (i.e. rotatable body 302 always abuts the piezoelectric element 102); by having a suitably shaped rotatable body 302 (e.g. a rotatable body 302 with a circular cross section) an having the rotatable body 302 always in abutment with the piezoelectric element 10 this ensures a continuous gradual change in force being applied to the piezoelectric element 102 as the rotatable body 302 is rotated, over time (this is in contrast to the assembly 4 of FIG. 2b wherein the force applied to the piezoelectric element 102 is a pulse). Due to the eccentric axle 303 the amount of mechanical force which the rotatable body 302 applies to the piezoelectric element 102 changes as the rotatable body 302 rotates about the eccentric axle 303. The mechanical force which the rotatable body 302 applies to the piezoelectric element 102 is a maximum when a first point 303a on a perimeter 303c of the rotatable body 302 which is furthest from the eccentric axle 303 abuts the piezoelectric element 102; the mechanical force which the rotatable body 302 applies to the piezoelectric element 102 is a minimum when a second point 303b on a perimeter 303c of the rotatable body 302 which is closest to the eccentric axle 303 abuts the piezoelectric element 102.

An increase in the amount of mechanical force which the rotatable body 302 applies to the piezoelectric element 102 (as the rotatable body 302 is rotated to bring the first point 303a on the perimeter 303c of the rotatable body 302 to abut the piezoelectric element 102) will result in a corresponding increase in the mechanical deformation of the piezoelectric element 102 and thus a corresponding increase in strain in the piezoelectric element 102. Likewise, a decrease in the amount of mechanical force which the rotatable body 302 applies to the piezoelectric element 102 (as the rotatable body 302 is rotated to move the first point 303a on the perimeter 303c of the rotatable body 302 away from the position where it abuts the piezoelectric element 102) will result in a corresponding decrease in the mechanical deformation of the piezoelectric element 102 and thus a corresponding decrease in strain in the piezoelectric element 102.

In a variation of assembly 6, the means 204 for applying a cyclical mechanical force to the piezoelectric element 102 force comprises a rotatable body with a centric axle which defines an axis of rotation about which the rotatable body 302 can be rotated. The rotatable body 302 has a cross section which has an asymmetrical shape e.g. the rotatable body 302 has a cross section which is elliptical-shaped. With such a profile the radial distance from the centric axle to the perimeter 303c changes over the length of the perimeter 303c (there are points on the permitter 303c which have a minimal distance to the centric axle and points which have a maximal distance to the centric axle). The rotatable body 302 is positioned such that it mechanically abuts the piezoelectric element 102 over a whole rotation about said centric axle. Over a full rotation of the rotatable body 302 about the centric axle, the piezoelectric material 302 will thus experience multiple cycles of increasing and decreasing force.

The assembly 6 can be used to perform a method for treating the polluted water 103, according to an embodiment of the present invention. During use a volume of polluted water 103 which is to be treated is provided in the vessel 100. The rotatable body 302 is then rotated about the eccentric axle 303. In the preferred embodiment the rotatable body 302 is the rotated at a rate in the range 10 Hz-10 kHz, about the eccentric axle 303.

Due to the eccentric axle 303 the amount of mechanical force which the rotatable body 302 applies to the piezoelectric element 102 changes as the rotatable body 302 rotates about the eccentric axle 303. The mechanical force which the rotatable body 302 applies to the piezoelectric element 102 is a maximum when a first point 303a on a perimeter 303c of the rotatable body 302 which is furthest from the eccentric axle 303 abuts the piezoelectric element 102; the mechanical force which the rotatable body 302 applies to the piezoelectric element 102 is a minimum when a second point 303b on a perimeter 303c of the rotatable body 302 which is closest to the eccentric axle 303 abuts the piezoelectric element 102.

An increase in the amount of mechanical force which the rotatable body 302 applies to the piezoelectric element 102 (as the rotatable body 302 is rotated to bring the first point 303a on the perimeter 303c of the rotatable body 302 to abut the piezoelectric element 102) will result in a corresponding increase in the mechanical deformation of the piezoelectric element 102 and thus a corresponding increase in strain in the piezoelectric element 102.

The increase in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103.

Likewise, a decrease in the amount of mechanical force which the rotatable body 302 applies to the piezoelectric element 102 (as the rotatable body 302 is rotated to move the first point 303a on the perimeter 303c of the rotatable body 302 away from the position where it abuts the piezoelectric element 102) will result in a corresponding decrease in the mechanical deformation of the piezoelectric element 102 and thus a corresponding decrease in strain in the piezoelectric element 102.

The decrease in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103.

In the preferred embodiment the strain induced by the piezoelectric element 102 by the rotatable body 302 is in the range 0.1%-50%.

FIG. 3b illustrates an assembly 7 according to another embodiment of the present invention, which can be used to perform a method according to an embodiment of the present invention.

The assembly 7 comprises many of the same features as the assembly 6 shown in FIG. 3a, and like features are awarded the same reference numbers.

In this embodiment the piezoelectric element 102 is anchored at a first end 102b to a fixed, immoveable part 215a of the assembly 6, so that the first end 102b is immovable; and the piezoelectric element 102 is anchored at a second end 102c to a fixed, immoveable part 215b of the assembly 6, so that the second end 102c is immovable. It should be understood that the piezoelectric element 102 may be anchored to a fixed, immoveable part of the assembly 7, along the whole of a perimeter of the piezoelectric element 102.

In the assembly 7 the means for straining the piezoelectric element 102 comprises a means 204 for applying a mechanical force to the piezoelectric element 102 which mechanically deforms the piezoelectric element 102. Specifically, in this example, said means 204 for applying a mechanical force to the piezoelectric element 102 comprises a first electrode 305 which has a predefined amount of electrical charge (which, in one embodiment, may vary over time (e.g. by supplying the first electrode 305 with an alternating voltage); or, in another embodiment is a constant non-zero electric charge (e.g. by supplying the first electrode 305 with a constant non-zero voltage)) and a second electrode 307, wherein the first and second electrodes 305,307 are arranged such that there is an gap 306 between the first and second electrodes 305,307. In this embodiment the gap 306 is an air gap (i.e. air fills the gap 306), however it should be understood that the gap 306 could be filled with an inert gas, elastic dielectricum, or a vacuum. Preferably, either the first and/or second electrodes 305,307, has an electrically insulating layer; most preferably—an electrically insulating layer is provided on the surface of the second electrode only which is facing the gap 306 and the first electrode 305 is without an electrically insulating layer so that the first electrode 305 can more easily be flexed. In another embodiment an electrically insulating layer is provided on the surface of the first electrode 305 which is facing the gap 306 and an electrically insulating layer is provided on the surface of the second electrode which is facing the gap 306.

There is further provided an electric circuit 308 which is electrically connected to the second electrode 307; the electric circuit 308 is configured such that it is operable to apply a cyclic voltage, or arbitrary voltage (e.g. a voltage whose level changes randomly), and thus a cyclic or arbitrary change of electrical charge to the second electrode 307. In the preferred embodiment the electric circuit 308 further comprises a current limiter.

In one embodiment the piezoelectric element 102 is arranged to abut said first electrode 305. However, in the assembly 7, which is a preferred embodiment, the piezoelectric element 102 is attached to said first electrode 305 (e.g. in an embodiment there is a layer of adhesive between the piezoelectric element 102 and the first electrode 305, and this layer of adhesive attaches the piezoelectric element 102 to the first electrode 305).

In this embodiment the first electrode 305 is anchored at a first end 305b to a fixed, immoveable part 215a of the assembly 6, so that the first end 305b is immovable; and the first electrode 305 is anchored at a second end 305c to a fixed, immoveable part 215b of the assembly 6, so that the second end 305c is immovable. The second electrode 307 is anchored at a first end 307b to a fixed, immoveable part 215a of the assembly 6, so that the first end 307b is immovable; and the first electrode 305 is anchored at a second end 307c to a fixed, immoveable part 215b of the assembly 6, so that the second end 307c is immovable. It should be understood that the first electrode 305 may be anchored to a fixed, immoveable part of the assembly 6 along the whole of a perimeter of first electrode 305; and the second electrode 307 may be anchored to a fixed, immoveable part of the assembly 7 along the whole of a perimeter of first electrode 305.

The assembly 7 can be used to perform a method for treating the polluted water 103, according to an embodiment of the present invention. During use a volume of polluted water 103 which is to be treated is provided in the vessel 100.

The electric circuit 308 is then operated to apply an cyclic voltage to the second electrode 307, thus a cyclic change of electrical charge is applied to the second electrode 307 so as to generate a cyclic electrostatic force. (In another embodiment, the electric circuit 308 is operated to apply an arbitrary voltage (e.g., a voltage whose level changes randomly) to the second electrode 307). This cyclic electrostatic force acts on the first electrode 305 to mechanically deform the first electrode 305; since piezoelectric element 102 is attached to said first electrode 305 any mechanical deformation of the first electrode 305 will result in a corresponding mechanical deformation of the piezoelectric element 102. Since the electric circuit 308 applies a cyclic voltage and thus a cyclic change of electrical charge to the second electrode 307 the cyclic electrostatic force which is generated will also be cyclic; in this embodiment the electrostatic force will increase with an increasing voltage applied to the second electrode 307 and the electrostatic force will decrease with decreasing voltage applied to the second electrode 307. The cyclic voltage may either be positive or negative throughout its whole cycle, in which case the electrostatic force will always either be directed towards or away from the second electrode 307, or it may vary between positive and negative voltage, in which case the electrostatic force will vary its direction according to the momentarily prevailing voltage.

As the electrostatic force which is generated increases the mechanical deformation of the piezoelectric element 102 will correspondingly increase; as the electrostatic force which is generated decreases the mechanical deformation of the piezoelectric element 102 will correspondingly decrease. An increase in the mechanical deformation of the piezoelectric element 102 will correspondingly increase strain in the piezoelectric element 102; a decrease in the mechanical deformation of the piezoelectric element 102 will correspondingly decrease stain in the piezoelectric element 102. For example, when an increasing voltage is applied to the second electrode 307 by the electric circuit 308, this will result in an increasing electrostatic force being generated, which will in turn increasingly mechanically deform the piezoelectric element 102 resulting in increasing strain in the piezoelectric element 102 (until the voltage is applied to the second electrode 307 reaches a maximum).

The increase in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103.

Likewise, when the voltage is applied to the second electrode 307 by the electric circuit 309, is decreasing, this will result in a decreasing electrostatic force being generated; as the electrostatic force decreases there will be less force to mechanically deform the piezoelectric element 102 thus allowing the piezoelectric element 102 to begin to elastically return to its original state (i.e. the state of the piezoelectric element 102 when there was no forces applied to the piezoelectric element 102); and thus resulting in decreasing strain in the piezoelectric element 102 (until the voltage is applied to the second electrode 307 reaches a minimum). For example, when the voltage applied to the second electrode 307 is reduced to ‘zero’ then there will be no electrostatic force generated and the piezoelectric element 102 will elastically return to its original state.

The decrease in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103.

In the assembly 7 since the ends 305b,305c of the first electrode 305 are fixed and immovable; and the first and second ends 102b,102c of the piezoelectric element 102 are fixed and immovable, and since the electric circuit 308 is operated to apply a cyclic voltage to the second electrode 307, the electrostatic force which is generated during the use of the assembly 7 will typically result in periodic mechanical deformation of the first electrode 305 and piezoelectric element 102; this periodic mechanical deformation of the first electrode 305 and piezoelectric element 102 may result in the vibration of a center 220 of the piezoelectric element 102.

In a variation of assembly 7, a second piezoelectric element is attached to the surface the second electrode 307 which is facing away from the gap 306. During use the both the first and second electrodes 305,307 are deformed from the generated electrostatic force; and when the second electrode 307 deforms it causes deformation of the second piezoelectric element which is attached to its surface; and when the first electrode 305 deforms it causes deformation of the piezoelectric element which is attached to its surface. Thus, in this variation there are two piezoelectric elements which are deformed and thus a larger amount of transient electric charges are generated which in turn cause the formation of a larger amount of reactive radical species available to degrade the pollutants in the polluted water 103.

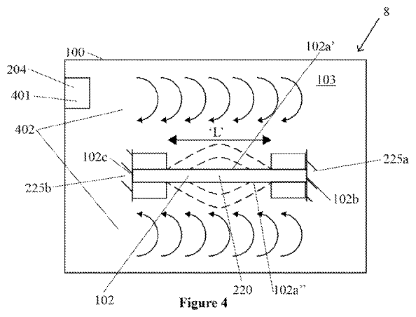

FIG. 4 illustrates an assembly 8 according to another embodiment of the present invention, which can be used to perform a method according to an embodiment of the present invention.

The assembly 8 comprises many of the same features as the assembly 6 shown in FIG. 3a, and like features are awarded the same reference numbers.

In this embodiment the piezoelectric element 102 is clamped at a first end 102b by a first clamp 225a of the assembly 6, so that the first end 102b is immovable; and the piezoelectric element 102 is clamped at a second end 102c by a second clamp 225b of the assembly 6, so that the second end 102c is immovable. The piezoelectric element 102 can be clamped by the first and second clamps 225a,225b at any suitable location along the length ‘L’ of the piezoelectric element 102—as will be discussed in more detail later location along the length ‘L’ of the piezoelectric element 102 at which it is clamped can be adjusted in order to tune the frequency at which the piezoelectric element 102 vibrates during use.

In the assembly 8 the means for straining the piezoelectric element 102 comprises a means 204 for applying a mechanical force to the piezoelectric element 102 which mechanically deforms the piezoelectric element 102. Specifically, in this example, a means 204 for applying a mechanical force to the piezoelectric element 102 comprises a flow generator 401 which is operable to generate a flow in the polluted water 103 that is in the vessel 100; the flow generator 401 is configured such that it can cause the polluted water 103 to flow in such a way that the polluted water 103 applies pushes against the piezoelectric element 102; the pushing force applied by the flowing polluted water 103 to the piezoelectric element 102 mechanically deforms the piezoelectric element 102 and thus causes a corresponding increase in strain in the piezoelectric element 102.

Preferably the flow generator 401 is configured such that it flows the polluted water 103 in a predefined flow pattern which results in a continuous turbulent flow along at least one surface 102a′,102a″ of the piezoelectric element 102. For example the flow generator 401 may be configured such that it flows the polluted water 103 at a velocity which is above a predefined threshold velocity necessary to achieve a Reynolds number above ‘2000’, so that a continuous turbulent (or transitional flow, which is a flow transitioning from a laminar flow to turbulent flow, and thus is a flow which contains both a turbulent flow component and a laminar flow component) along at least one surface 102a′,102a″ of the piezoelectric element 102 is achieved. As is know in the art, a turbulent flow is inherently characterized by irregularity, wherein the local flow direction of the polluted water 103 will arbitrarily deviate from the general flow direction. Said arbitrary deviations of local flow direction will impart a changing force and hence a changing deformation and strain onto the piezoelectric element 102. The arbitrary change of flow direction can be characterized in terms of a frequency content, said frequency content preferably contains frequencies between 10 Hz to 100 kHz. The arrows illustrated in FIG. 4 are an example of a flow pattern; the illustrated flow pattern is an ‘eddy flow’ (however it should be understood that the flow generator 401 may be configured to provide any suitable flow pattern). In the illustrated ‘eddy flow’ flow pattern the polluted water 103 flows against opposing surfaces 102a′, 102a″ of the piezoelectric element 102, causing the portion of the piezoelectric element 102 which is close to the center 220, to oscillate or vibrate.

It should be noted that in the present application the term “flow pattern” includes, but is not limited to the velocity which the flow generator 401 flows the polluted water 103, the direction in which the flow generator 401 flows the polluted water 103, and/or the volume of the polluted water 103 which the flow generator 401 flows.

In this embodiment the flow generator 401 flows the polluted water 103 at a constant predefined velocity, the velocity at which the flow generator 401 flows the polluted water 103 results (due to a natural phenomenon) in a continuous turbulent flow along at least one surface 102a′,102a″ of the piezoelectric element 102.

In another embodiment the flow generator 401 is configured such it can change the flow pattern over a predefined time period, so that the mechanical force which polluted water 103 applies to the piezoelectric element 102 varies over that time period. This is in contrast to the previous embodiment wherein the flow generator 401 flows the polluted water 103 at a constant flow pattern and the mechanical forces on the piezoelectric element 102 resulted from the resulting natural phenomenon of turbulent flow along at least one surface 102a′,102a″ of the piezoelectric element 102.

For example, is said other embodiment, the flow generator may be configured to flow the polluted water 103 at a changing velocity over time; in yet another embodiment the flow generator 401 may be configured such it can change the direction which it flows the polluted water 103 flows over a predefined time period. This change in velocity and/or flow direction results in the polluted water 103 applying a net mechanical force to the piezoelectric element 102. When the direction/velocity of flow is changed by the flow generator 401 the net force applied to the piezoelectric element 102 changes direction/velocity and this results in a change in the mechanical deformation of the piezoelectric element 102. If the flow of the polluted water 103 is stopped the piezoelectric element 102 will vibrate freely from the release of the stored potential energy of said elastic deformation as it elastically returns to its original state. Hence, in this embodiment, the strain in the piezoelectric element 102 is caused both by the mechanical force applied by the flowing polluted water 103 to the piezoelectric element 102; and also the subsequent free vibrations which the piezoelectric element 102 undergoes after the flow of the polluted water 103 is stopped, and the piezoelectric element 102 elastically returns to its original state.

The shape and clamping of piezoelectric element 102 is preferably such that vibrational modes or eigenfrequencies of the piezoelectric element 2 harmonize with the frequency or the frequency content of the flow. For example, the piezoelectric material might be provided in the shape of a thin, circular plate or foil, and said circular plate is fixed along its circumferences. As is known to experts, the vibrational modes and eigenfrequencies of such an arrangement would, among other factors, depend on the thickness and the radius of said circular foil. Hence, the location along the length ‘L’ at which the piezoelectric element 102 is clamped by the first and second clamps 225a,225b; and the shape of the piezoelectric element 102 can be chosen to be the same or a multiple of the characteristic frequency of the flow, resulting in a resonant vibration of the piezoelectric element 102. Suitable eigenfrequency for the vibrational modes of the piezoelectric material are in a frequency range of 10 Hz to 100 kHz and have strains of 0.1% to 50%.

It should be noted that in a further embodiment, which is a variation of the embodiment shown in FIG. 4, only the first end 102b of the piezoelectric element 102 is fixed to an immoveable part 215a of the assembly 6, so that the first end 102b is immovable, and the second end 102c is a free end. Preferably in this further embodiment the assembly may further comprise one or more bearings which are arranged to abut the piezoelectric element 102 a position between the first and second ends 102b,c, wherein said position of the bearings may be adjusted so that the piezoelectric element 102 deforms a predefined amount for a given flow profile. Preferably, the one or more bearings define a fulcrum; and the portion of the piezoelectric element 102 which is between the second, free end 102c, and the point along the piezoelectric element 102 at which the bearings abut the piezoelectric element 102, can be moved by the flowing polluted water 103.

The assembly 8 can be used to perform a method for treating the polluted water 103, according to an embodiment of the present invention. During use a volume of polluted water 103 which is to be treated is provided in the vessel 100. The flow generator 401 is then operated to generate a flow in the polluted water 103 that is in the vessel 100.

In the most preferred embodiment the flow generator 401 generates a flow pattern in which the direction of flow of the polluted water 103 changes over a predefined time period. This change in flow direction results in the polluted water 103 applying a net mechanical force to the piezoelectric element 102. When the flow of the polluted water 103 is against the piezoelectric element 102 the polluted water 103 applies a mechanical force to the piezoelectric element 102 which mechanically deforms the piezoelectric element 102; this results in an increase in the stain within the piezoelectric element 102.

The increase in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103.

Likewise, when the direction of flow of the polluted water 103 is stopped, or, is changed to a direction in which flow of the polluted water 103 is no longer applying a mechanical force to piezoelectric element 102; the piezoelectric element 102 will vibrate freely from the release of the stored potential energy of said elastic deformation as it elastically returns to its original state. As the piezoelectric element 102 elastically returns to its original state this will result in a corresponding decrease in strain in the piezoelectric element 102.

The decrease in the strain within the piezoelectric element 102 will give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103.

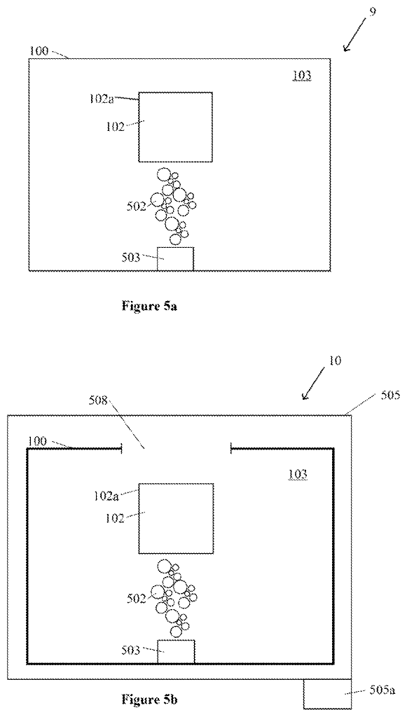

FIG. 5a illustrates an assembly 9 according to another embodiment of the present invention, which can be used to perform a method according to an embodiment of the present invention.

The assembly 9 comprises many of the same features as the assembly 1 shown in FIG. 1a, and like features are awarded the same reference numbers.

In the assembly 9 the means for straining the piezoelectric element 102 comprises a means for comprises a means for injecting bubbles 502 of gas into the polluted water 103 in the vessel 100; the means for injecting bubbles 502 of gas into the polluted water 103 in the vessel 100 is in the form of a gas injecting device 503. Preferably the gas injecting device 503 is configured to inject bubbles 502 of gas which comprise at least one or more of, air, oxygen, and/or ozone gas. Most preferably the gas injecting device 503 is configured to inject bubbles 502 of gas which comprise at oxygen and/or ozone. However, it should be understood that the bubbles 502 may have any suitable composition.

The gas injecting device 503 may comprise one or more nozzles and/or one or more bubble diffuser, and/or any other suitable means to facilitate the injection of the bubbles 502 of gas into the polluted water 103 in the vessel 100.

The assembly 9 can be used to perform a method for treating the polluted water 103, according to an embodiment of the present invention. During use a volume of polluted water 103 which is to be treated is provided in the vessel 100. The gas injecting device 503 is operated to inject bubbles 502 of ozone, or oxygen, gas into the polluted water 103.

The bubbles 502 are then moved towards the piezoelectric element 102. In one embodiment the bubbles 502 simply migrate passively towards the piezoelectric element 102; in another embodiment the method involves generating a flow within the polluted water 103 and transporting the bubbles 502 in said flow towards the piezoelectric element 102.

The bubbles 502 then burst within the polluted water 103. The busting of each bubble 502 generates a respective shockwave which is transmitted to the piezoelectric element 102; the shockwaves cause stain within the piezoelectric element 102.

It should be understood that bubbles 502 can burst anywhere within the polluted water 103. Regardless of where a bubble 502 bursts it will create a shockwave which will be transmitted (e.g. via the polluted water 103 as a medium though which the shockwave can travel) to the piezoelectric element 102. However, the closer a bubble 502 is to the piezoelectric element 102 when it bursts the larger the amount of the shockwave will be received by the piezoelectric element 102, and thus the greater the strain caused in the piezoelectric element 102. Accordingly, preferably the bubbles 502 burst at the piezoelectric element 102 (e.g. at the surface 102a of the piezoelectric element 102), or, in close proximity to the piezoelectric element 102. For example, a bubble 502 impacting the surface 102a of the piezoelectric element 102 will cause that bubble 502 to burst. When a bubble 502 bursts at the surface 102a of the piezoelectric material then the shockwave generated by that bursting bubble 502 is transmitted directly into the piezoelectric element 102; whereas the shockwave generated by a bubble 502 that bursts at a location away from the surface 102a of the piezoelectric element 102 will first need to propagate through the polluted water 103 to the surface 102a of the piezoelectric element 102 before it causes stain in the piezoelectric element 102. In the preferred embodiment the bubbles 502 move towards the piezoelectric element 102 and burst upon impacting the surface 102a of the piezoelectric element 102.

The strain caused in the piezoelectric element 102 by the shockwaves generated by the bursting of the bubbles 502, give rise to the generation of transient electric charges on the surface 102a of said piezoelectric element 102. These transient electric charges on the surface 102a of said piezoelectric element 102 cause the formation of reactive radical species, such as hydroxyl or superoxide radicals for example, on the surface 102a of the piezoelectric element 102 (these reactive radical species may be formed using Oxygen taken from water molecules of the polluted water 103); said reactive radical species react with pollutants in the polluted water 103 which are in contact with the surface 102a of the piezoelectric element 102 and/or which are in close proximity to the piezoelectric element 102; the reactions between the said reactive radical species and pollutants are redox reactions. Said redox reactions between the said reactive radical species and pollutants degrades the pollutants in the polluted water 103.

In a further embodiment the method further comprises the step of using said shockwaves which are generated by the busting of the bubbles 502 to destroy organic pollutants in the polluted water 103.

FIG. 5b illustrates an assembly 10 according to another embodiment of the present invention, which can be used to perform a method according to an embodiment of the present invention.

The assembly 10 comprises many of the same features as the assembly 9 shown in FIG. 5a, and like features are awarded the same reference numbers. The assembly 10 further comprises a vacuum chamber 505 in which the vessel 100 can be housed; and a vacuum generating means 505a which is selectively operable to generate a vacuum within the vacuum chamber 505.

The assembly 10 operates in substantially the same way as the assembly 9 to carry out a method of treating polluted water 103 according to an embodiment of the present invention; however using the assembly 10 further comprises the steps of operating the vacuum generating means 505a to generate a vacuum within the vacuum chamber 505. In the assembly 9 the vessel 100 is preferably closed during use, whereas, in contrast, in the assembly 10 preferably has an opening 508 defined in the vessel 100 which remains open during use, so that the polluted water 103 in the vessel 100 and the bubbles 502 generated by the gas injecting device 503 are exposed to the vacuum generated in the vacuum chamber 505. Advantageously the vacuum provided by the vacuum generating means 505a promotes the formation of gas bubbles 502 in the polluted water 103.

In a further embodiment of method of treating polluted water 103 according to an embodiment of the present invention, using any of the assemblies of FIGS. 1a,1b,5a or 5b, in this application, there is a further step of adding one or more additives, such as surfactants, to said polluted water 103 in the vessel 100, wherein said additive has a composition which promotes the formation of bubbles 502 in the polluted water 103.

Various modifications and variations to the described embodiments of the invention will be apparent to those skilled in the art without departing from the scope of the invention as defined in the appended claims. Although the invention has been described in connection with specific preferred embodiments, it should be understood that the invention as claimed should not be unduly limited to such specific embodiment.

1. An assembly for treating polluted water, the assembly comprising,
a vessel which defines a volume in which said polluted water can be located;
piezoelectric element located within said volume;
a means for straining the piezoelectric element so as to generate transient electric charges on a surface of said piezoelectric element so that said generated transient electric charges cause redox reactions which degrade pollutants in the polluted water, wherein the means for straining the piezoelectric element comprises a hydrodynamic cavitation device which, when operated, generates cavitation bubbles in the polluted water and/or flow in the polluted water; and wherein the piezoelectric element comprises a matrix which comprises polymeric material, and piezoelectric particles embedded in the matrix.

2. An assembly according to claim 1 wherein the means for straining the piezoelectric element comprises a means for deforming the piezoelectric element.

3. (canceled)

4. (canceled)

5. An assembly according to claim 1 wherein the piezoelectric element is a structure which is located within the volume of the vessel and is mechanically independent of the means for deforming the piezoelectric element.

6-31. (canceled)

32. An assembly according to claim 1 wherein the means for straining the piezoelectric element comprises a means for flowing the polluted water in the vessel so that the flowing polluted water applies a mechanical force to the piezoelectric element which deforms the piezoelectric element.

33. (canceled)

34. An assembly according to claim 32 wherein the means for flowing the polluted water in the vessel comprises a means for varying a flow profile of the polluted water over a time period, so that the mechanical force which polluted water applies to the piezoelectric element varies over that time period.

35. (canceled)

36. An assembly according to claim 1 wherein the means for straining the piezoelectric element comprises a means for injecting bubbles of gas into the polluted water in the vessel, wherein the busting of each bubble of gas generates a shockwave which is transmitted to the piezoelectric element, and the shockwaves cause deformation of the piezoelectric element.

37-41. (canceled)

42. A method for treating polluted water using the assembly according to claim 1, the method comprising the steps of,
bringing said water in contact with piezoelectric element so that the pollutants in the water come into contact with the surfaces of the piezoelectric element;
straining the piezoelectric element so as to generate transient electric charges on a surface of said piezoelectric element;
using said generated transient electric charges to cause redox reactions which degrade pollutants in the water.

43. (canceled)

44. A method according to claim 42 wherein the step of straining the piezoelectric element so as to generate transient electric charges on the surface of said piezoelectric element, comprises,
generating bubbles within the polluted water; and
collapsing said generated bubbles, wherein the collapsing of each bubble generates a shockwave which is transmitted to the piezoelectric element, so that said shockwaves cause deformation of the piezoelectric element so as to generate transient electric charges on the surface of said piezoelectric element.

45. A method according to claim 44 wherein the step of generating bubbles within the polluted water comprises using hydrodynamic cavitation to generate said bubbles and, wherein the step of using hydrodynamic cavitation to generate bubbles comprises, flowing the polluted water through a rigid structure to cause a pressure drop sufficient to cause cavitation.

46-50. (canceled)

51. A method according to claim 42 wherein the step of straining the piezoelectric element so as to generate transient electric charges on the surface of said piezoelectric element, comprises flowing the polluted water against the piezoelectric element so that polluted water applies a force to the piezoelectric element which causes the piezoelectric element to deform so transient electric charges are generated on the surface of said piezoelectric element.

52-59. (canceled)

60. A method according to claim 42 wherein the step of straining the piezoelectric element so as to generate transient electric charges on the surface of said piezoelectric element, comprises injecting bubbles of gas into said polluted water; busting said injected bubbles, wherein the busting of each bubble generates a shockwave which is transmitted to the piezoelectric element, so that said shockwaves cause deformation of the piezoelectric element so as to generate transient electric charges on the surface of said piezoelectric element.

61-63. (canceled)

64. A method according to claim 42 wherein the step of using said generated transient electric charges to cause redox reactions which degrade pollutants in the water, comprises using said generated transient electric charges to cause redox reactions which cause oxidization of pollutants in the water, and/or comprises using said generated transient electric charges to cause redox reactions which cause reduction of pollutants in the water.

65. (canceled)

66. An assembly according to claim 1 wherein the assembly comprises a single piezoelectric element or a plurality of piezoelectric elements and wherein the single piezoelectric element is in the form of a sheet, fiber, or, wherein the plurality of piezoelectric elements comprise, a plurality of cylindrical particles, and/or a plurality of spherical particles, and/or a plurality of cuboidal particles.

67. (canceled)

68. An assembly according to claim 1 wherein the piezoelectric element(s) occupy less than 70% of the volume defined by the vessel.

69. An assembly according to claim 1, wherein the piezoelectric element(s) comprises a material with a macroscopic young's modulus between 10 MPa and 500 MPa.
